(19) United States
(12) Patent Application Publication
(10) Pub. No.: US 2014/0192412 A1
(43) Pub. Date: Jul. 10, 2014

(54) PACKAGE, OPTICAL MODULE, AND ELECTRONIC APPARATUS

(71) Applicant: Seiko Epson Corporation, Tokyo (JP)

(72) Inventor: Hideo Imai, Shimosuwa-machi (JP)

(73) Assignee: Seiko Epson Corporation, Tokyo (JP)

(21) Appl. No.: 14/148,925

(22) Filed: Jan. 7, 2014

(30) Foreign Application Priority Data
Jan. 7, 2013 (JP) 2013-000355

(51) Int. Cl. G02B 27/00; G02B 26/00; G02B 5/28

(52) U.S. Cl. CPC G02B 27/0006; G02B 5/284; G02B 26/001
USPC 359/514; 359/513

(57) ABSTRACT

A base substrate, a lid that forms an internal space capable of housing a device (variable-wavelength interference filter), and a brazing filler that joins the lid to the base substrate are provided. The lid has: a lid joining portion having a base facing surface that faces the base substrate, an inner lateral surface that continues at an inner end on the side of the internal space of the base facing surface and faces the internal space, an outer lateral surface, and an upper surface; and a lid sidewall portion standing up in a direction away from the base substrate from the upper surface of the lid joining portion. The brazing filler is provided along the base facing surface and the outer lateral surface from the inner end to the upper end of the outer lateral surface via an outer end opposite to the inner end.

### BACKGROUND

1. Technical Field

The present invention relates to a package, an optical module, and an electronic apparatus.

2. Related Art

Traditionally, an electronic component housing container for airtightly sealing and housing various electronic components (devices) such as semiconductor elements and piezoelectric oscillators in order to enable the electronic components to operate normally over a long period without deteriorating characteristics thereof, is known (see, for example, JP-A-2006-210628).

The electronic component housing container disclosed in JP-A-2006-210628 has an insulating base unit that has, on an upper surface thereof, a wire conductor for electrically connecting electronic components, and a lid unit that has, on a lower surface thereof, a recessed portion for housing the electronic components and that has the lower surface joined to the upper surface of the insulating base unit via a sealant. The sealant forms a fillet expanding as it goes from a wall surface of a sidewall of the lid unit toward the insulating base unit, on both the outer and inner sides of the electronic component housing container.

However, in a package having electronic components housed in a container that has a base substrate and a lid unit (lid) joined to the base substrate via a sealant, as in the electronic component housing container disclosed in JP-A-2006-210628, if a fillet of the sealant is formed to expand on the inner side of the package as it goes from an inner wall surface of a sidewall toward the base substrate inside the package, the fillet and members such as devices and wires housed within the package may interfere with each other.

In order to prevent the interference, a large space needs to beset inside the package to secure a space for forming the fillet. This causes a problem that the package is increased in size.

Also, since the fillet is formed to expand as it goes from the sidewall toward the base substrate inside the package, there is a problem that the amount of the sealant used increases, thus increasing the manufacturing cost.

### SUMMARY

An advantage of some aspects of the invention is that a package, an optical module and an electronic apparatus that can be reduced in size can be provided.

An aspect of the invention is directed to a package including: a device; a base substrate; a lid that is joined to the base substrate and forms an internal space capable of housing the device between the base substrate and the lid; and a brazing filler that joins the lid to the base substrate. The lid has a lid joining portion having a base facing surface that faces the base substrate, an inner lateral surface that continues at an inner end on the side of the internal space of the base facing surface and faces the internal space, an outer lateral surface that continues at an outer end opposite to the inner end of the base facing surface, and an upper surface that continues at an upper end opposite to the outer end of the outer lateral surface. The lid also has a lid sidewall portion standing up in a direction away from the base substrate from the upper surface of the lid joining portion. The brazing filler is provided along the base facing surface and the outer lateral surface from the inner end to the upper end via the outer end.

According to this aspect of the invention, the base substrate and the lid are jointed together by brazing. As the brazing filler, for example, a hard brazing filler such as sliver brazing filler may be used or a soft brazing filler such as solder may be used.

In the package, the brazing filler is provided along the base facing surface and the outer lateral surface from the inner end of the base facing surface of the lid joining portion to the upper end of the outer lateral surface via the outer end of the base facing surface.

In the package thus configured, the brazing filler does not contact the inner lateral surface of the lid joining portion, and the brazing filler is provided to contact the lid joining portion on the outer side of the inner end, from the inner end of the base facing surface of the lid joining portion.

Therefore, the volume of the brazing filler formed inside the package can be reduced, compared with the case where a fillet expanding toward the inner side from the inner lateral surface of the lid joining portion is formed inside the package. Thus, there is no need to secure a space within the package for preventing interference between the fillet and various members arranged inside the package, and therefore the package can be reduced in size.

Moreover, since a fillet expanding toward the inner side from the inner lateral surface of the lid joining portion is not formed inside the package, the volume of the brazing filler can be reduced. Therefore, the amount of the brazing filler used can be restrained and the manufacturing cost can be restrained.

Also, in the package, the brazing filler is formed up to the upper end of the outer lateral surface where the outer lateral surface and the upper surface of the lid joining portion connect to each other. Therefore, a fillet that can secure joining strength and airtightness can be formed on the outer side of the lid joining portion.

Moreover, since the fillet is formed on the outer side of the lid joining portion, brazing is properly carried out, and whether joining strength and airtightness are secured or not can be visually recognized easily.

In the package of the aspect of the invention described above, it is preferable that an area of a region facing the device on the base substrate is equal to or greater than 90% of an area of a region on the inner side from a position facing the inner end on the base substrate, as viewed in a plan view seen from a direction of thickness of the base substrate.

According to this configuration, the proportion of the region facing the device to the region on the inner side from the inner end of the lid joining portion is 90% or greater, as viewed in the plan view of the base substrate. Thus, the size of a gap between the device and the inner surface of the lid can be reduced in a direction of width orthogonal to the direction of thickness of the base substrate, and the package can be reduced in size.

In the package of the aspect of the invention described above, it is preferable that the inner lateral surface has lower wettability to the brazing filler than the base facing surface.

If the brazing filler climbs up the inner lateral surface of the lid joining portion, the brazing filler cannot be secured in a sufficient amount to form a fillet on the outer lateral surface of the lid joining portion and desired joining strength and airtightness may not be achieved.

However, according to the configuration described above, since the wettability of the inner lateral surface of the lid joining portion to the brazing filler is made lower than that of the base facing surface, the climbing of the brazing filler on the inner lateral surface from the inner end of the base facing surface can be restrained. Thus, formation of a fillet expanding to the inner side of the lid can be deterred.

In the package of the aspect of the invention described above, it is preferable that a metal pattern having higher wettability to the brazing filler than the base substrate is provided on the base substrate, and that the metal pattern is provided on the outer side from a position facing the inner end, as viewed in a plan view seen from a direction of thickness of the base substrate.

According to this configuration, a metal pattern having higher wettability to the brazing filler than the base substrate is provided on the base substrate on the outer side from the inner end of the lid joining portion, as viewed in a plan view seen from a direction of thickness of the base substrate. Since the metal pattern is formed, a fillet extending from an end of the metal pattern to the inner end of the base facing surface is formed between the lid joining portion and the base substrate. That is, on the base substrate, the brazing filler does not expand toward the internal space of the metal pattern and an inconvenience of a fillet being formed on the inner side from the lid joining portion can be restrained.

In the package of the aspect of the invention described above, it is preferable that an angle formed by the outer lateral surface and the upper surface is an acute angle.

According to this configuration, since the angle formed by the outer lateral surface and the upper surface of the lid joining portion is an acute angle, the climbing of the brazing filler to the upper surface of the lid joining portion can be restrained. Thus, a fillet can be suitably formed from the outer lateral surface of the lid joining portion. Joining strength and airtightness can be secured while the amount of the brazing filler used is restrained.

In the package of the aspect of the invention described above, it is preferable that an angle formed by the base facing surface and the outer lateral surface is an obtuse angle.

According to this configuration, since the angle formed by the base facing surface and the outer lateral surface of the lid joining portion is an obtuse angle, the climbing of the brazing filler to the upper surface of the lid joining portion can be restrained. Thus, a fillet can be suitably formed to the outer lateral surface of the lid joining portion. Joining strength and airtightness can be secured while the amount of the brazing filler used is restrained.

In the package of the aspect of the invention described above, it is preferable that the device is an interference filter having a first substrate, a second substrate facing the first substrate, a first reflection film that is provided on the first substrate, reflects a part of incident light and transmits a part of the incident light, and a second reflection film that is provided on the second substrate, faces the first reflection film, reflects a part of incident light and transmits a part of the incident light.

According to this configuration, an interference filter is housed as the device in the package. When this interference filter is used, if charged particles enter into the package, the first reflection film and the second reflection film become electrically charged and the gap between the reflection films changes due to the influence of a Coulomb force. Therefore, desired performance may not be achieved. Also, if foreign matters such as water particles enter, an inconvenience of deterioration of the first reflection film and the second reflection film is more likely to happen.

To cope with such problems, according to the present configuration, an interference filter is housed inside the package and therefore joining strength and airtightness can be secured while the package is reduced in size as in the foregoing configurations. Thus, deterioration of the interference filter can be deterred and desired performance can be achieved.

Also, a variable-wavelength interference filter capable of changing the gap dimension between the reflection films may be used as the interference filter. In this case, by reducing the pressure of air inside the package, good responsiveness can be obtained when the gap dimension is changed.

Another aspect of the invention is directed to an optical module including: an interference filter having a first substrate, a second substrate facing the first substrate, a first reflection film that is provided on the first substrate, reflects a part of incident light and transmits a part of the incident light, and a second reflection film that is provided on the second substrate, faces the first reflection film, reflects a part of incident light and transmits a part of the incident light; a detection unit that detects light taken out by the first reflection film and the second reflection film; a base substrate; a lid that is joined to the base substrate and forms an internal space capable of housing the interference filter between the base substrate and the lid; and a brazing filler that joins the lid to the base substrate. The lid has a lid joining portion having a base facing surface that faces the base substrate, an inner lateral surface that continues at an inner end on the side of the internal space of the base facing surface and faces the internal space, an outer lateral surface that continues at an outer end opposite to the inner end of the base facing surface, and an upper surface that continues at an upper end opposite to the outer end of the outer lateral surface. The lid also has a lid sidewall portion standing up in a direction away from the base substrate from the upper surface of the lid joining portion. The brazing filler is provided along the base facing surface and the outer lateral surface from the inner end to the upper end via the outer end.

According to this configuration, as in the foregoing configurations, while the casing is reduced in size, joining strength and airtightness can be secured and entry of water particles, charged particles and the like can be prevented. Thus, there is no deterioration of the reflection films due to the entry of such particles and light with a target wavelength can be taken out with high resolution via the interference filter. By integrally controlling the interference filter and the detection unit, accurate detection of the amount of light can be carried out.

Still another aspect of the invention is directed to an electronic apparatus including: an interference filter having a first substrate, a second substrate facing the first substrate, a first reflection film that is provided on the first substrate, reflects a part of incident light and transmits a part of the incident light, and a second reflection film that is provided on the second substrate, faces the first reflection film, reflects a part of incident light and transmits a part of the incident light; a control unit that controls the interference filter; a base substrate; a lid that is joined to the base substrate and forms an internal space capable of housing the interference filter between the base substrate and the lid; and a brazing filler that joins the lid to the base substrate. The lid has a lid joining portion having a base facing surface that faces the base substrate, an inner lateral surface that continues at an inner end on the side of the internal space of the base facing surface and faces the internal space, an outer lateral surface that continues at an outer end opposite to the inner end of the base facing surface, and an upper surface that continues at an upper end opposite to the outer end of the outer lateral surface. The lid also has a lid sidewall portion standing up in a direction away from the base substrate from the upper surface of the lid joining portion. The brazing filler is provided along the base facing surface and the outer lateral surface from the inner end to the upper end via the outer end.

According to this configuration, as in the foregoing configurations, while the casing is reduced in size, joining strength and airtightness can be secured and entry of water particles, charged particles and the like can be prevented. Thus, an electronic apparatus in which there is no deterioration of the reflection films due to the entry of such particles and which can take out light with a target wavelength with high resolution via the interference filter and can operate stably over a long period, can be provided.

### BRIEF DESCRIPTION OF THE DRAWINGS

The invention will be described with reference to the accompanying drawings, wherein like numbers reference like elements.

FIG. 1 is a perspective view showing the schematic configuration of an optical filter device according to a first embodiment of a device of the invention.

FIG. 2 is a sectional view showing the schematic configuration of the optical filter device according to the first embodiment.

FIG. 3 is a plan view showing the schematic configuration of an interference filter housed in the optical filter device according to the first embodiment.

FIG. 4 is a sectional view showing the schematic configuration of a variable-wavelength interference filter according to the first embodiment.

FIG. 5 is a sectional view showing the schematic configuration of the peripheries of a joining portion according to the first embodiment.

FIG. 6 shows processes of manufacturing an optical filter device.

FIG. 7 is a sectional view showing the schematic configuration of the peripheries of a joining portion according to a second embodiment.

FIG. 8 is a sectional view showing the schematic configuration of the peripheries of a joining portion according to a modification of the embodiment.

FIG. 9 is a sectional view showing the schematic configuration of the peripheries of a joining portion according to a third embodiment.

FIG. 10 is a block diagram showing the schematic configuration of a color measurement device according to a fourth embodiment.

FIG. 11 is a schematic view showing a gas detection device having an optical filter device.

FIG. 12 is a block diagram showing the configuration of a control system of the gas detection device of FIG. 11.

FIG. 13 shows the schematic configuration of a food analyzer having an optical filter device.

FIG. 14 is a schematic diagram showing the schematic configuration of a spectroscopic camera having an optical filter device.

### DESCRIPTION OF EXEMPLARY EMBODIMENTS

### First Embodiment

Hereinafter, a first embodiment of the invention will be described with reference to the drawings.

### Configuration of Optical Filter Device

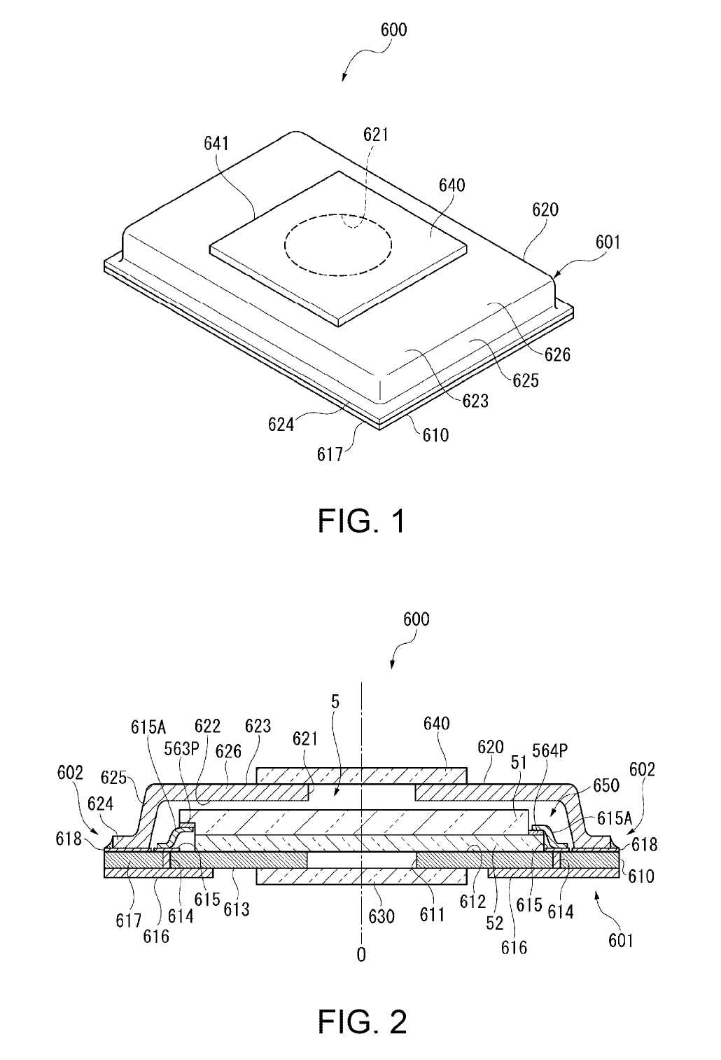

FIG. 1 is a perspective view showing the schematic configuration of an optical filter device 600 according to a first embodiment of a package of the invention. FIG. 2 is a sectional view of the optical filter device 600.

The optical filter device 600 is a device that takes out light with a predetermined target wavelength from inspection target light incident thereon and causes the resulting light to exit. The optical filter device 600 has a casing 601 and a variable-wavelength interference sensor 5 (see FIG. 2) as a device according to the invention housed inside the casing 601. Such an optical filter device 600 can be incorporated in, for example, an optical module such as a color measurement sensor, or an electronic apparatus such as a color measurement device or gas analyzer. The configuration of an optical module or electronic apparatus having the optical filter device 600 will be described in a second embodiment, later described.

### Configuration of Variable-Wavelength Interference Filter

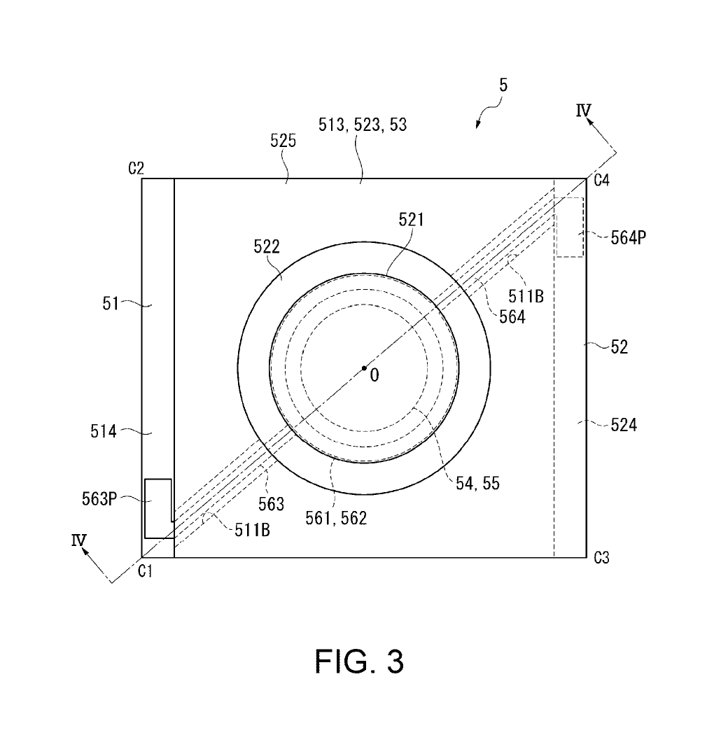

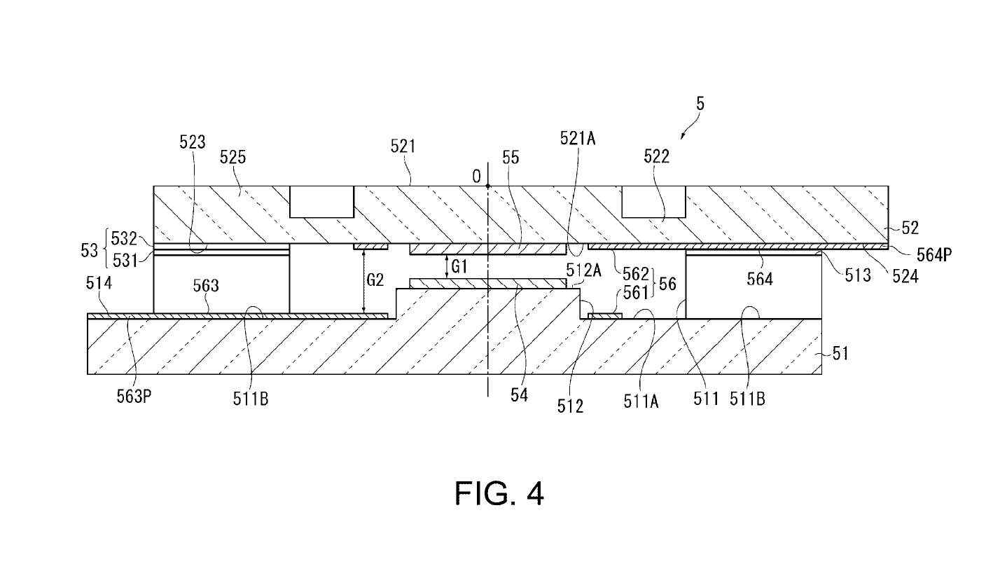

The variable-wavelength interference sensor 5 forms an interference filter according to the invention. FIG. 3 is a plan view showing the schematic configuration of the variable-wavelength interference sensor 5 provided in the optical filter device 600. FIG. 4 is a sectional view showing the schematic configuration of the variable-wavelength interference sensor 5, taken along IV-IV in FIG. 3.

As shown in FIG. 3, the variable-wavelength interference sensor 5 has a fixed substrate 51 as a first substrate according to the invention, and a movable substrate 52 as a second substrate according to the invention. The fixed substrate 51 and the movable substrate 52 are integrally formed as a first joining portion 513 of the fixed substrate 51 and a second joining portion 523 of the movable substrate are joined together via a joining film 53 (a first joining film 531 and a second joining film 532) formed, for example, by a plasma polymerized film containing siloxane as a principal component, or the like.

In the following description, a plan view seen from the direction of substrate thickness of the fixed substrate 51 or the movable substrate 52, that is, a plan view of the variable-wavelength interference sensor 5 seen from the direction in which the fixed substrate 51, the joining film 53 and the movable substrate 52 are stacked, is referred to as a filter plan view.

In the filter plan view, one side of the fixed substrate 51 (for example, a side between vertices C1 and C2 in FIG. 3) protrudes outward from the movable substrate 52. Of this protruding part, a surface that is exposed when the variable-wavelength interference sensor 5 is viewed from the side of the movable substrate 52 forms a first electric installation surface 514.

Also, in the filter plan view, one side facing the first electric installation surface 514 (a side between vertices C3 and C4), of the sides of the movable substrate 52, protrudes outward from the fixed substrate 51. Of this protruding part, a surface that is exposed when the variable-wavelength interference sensor 5 is viewed from the side of the fixed substrate 51 forms a second electric installation surface 524.

### Configuration of Fixed Substrate

As shown in FIG. 4, an electrode arrangement groove 511 and a reflection film installation portion 512 are formed on the fixed substrate 51. The fixed substrate 51 is formed to a larger thickness dimension than the movable substrate 52 and therefore there is no flexure of the fixed substrate 51 due to an electrostatic attraction generated when a voltage is applied between a fixed electrode 561 and a movable electrode 562 or due to internal stress of the fixed electrode 561.

The electrode arrangement groove 511 is formed annularly about a center point O of the variable-wavelength interference sensor 5, as viewed in the filter plan view. The reflection film installation portion 512 is formed protruding toward the movable substrate 52 from a central part of the electrode arrangement groove 511, as viewed in the plan view. Here, a groove bottom surface of the electrode arrangement groove 511 is an electrode installation surface 511A where the fixed electrode 561 is arranged. A protruding distal end surface of the reflection film installation portion 512 is a reflection film installation surface 512A, where a fixed reflection film 54 is installed.

Also, on the fixed substrate 51, an electrode lead-out groove 511B extending from the electrode arrangement groove 511 toward the first electric installation surface 514 and the second electric installation surface 524 is provided.

The fixed electrode 561 is provided on the electrode installation surface 511A of the electrode arrangement groove 511. The fixed electrode 561 is provided in a region facing the movable electrode 562 of the movable portion 521, later described, on the electrode installation surface 511A.

On the fixed substrate 51, a fixed lead-out electrode 563 extending from an outer peripheral edge of the fixed electrode 561 to the first electric installation surface 514 through the electrode lead-out groove 511B is provided. An extending distal end portion of the fixed lead-out electrode 563 (a portion situated at the vertex C1 of the fixed substrate 51) forms a fixed electrode pad 563P on the first electric installation surface 514.

In this embodiment, a configuration in which one fixed electrode 561 is provided on the electrode installation surface 511A is described. However, for example, a configuration in which two electrodes that are concentric about the center point O in the plan view are provided (double-electrode configuration) may also be employed.

Of the surface facing the movable substrate 52 of the fixed substrate 51, a surface where the electrode arrangement groove 511, the reflection film installation portion 512 and the electrode lead-out groove 511B are not formed forms the first joining portion 513. The first joining film 531 is formed on the first joining portion 513. As the first joining film 531 is joined to the second joining film 532 provided on the movable substrate 52, the fixed substrate 51 and the movable substrate 52 are jointed together, as described above.

### Configuration of Movable Substrate

The movable substrate 52 has the circular movable portion 521 about the plan center point O in the filter plan view as shown in FIG. 3, a holding portion 522 provided on the outside of the movable portion 521 and holding the movable portion 521, and a substrate outer peripheral portion 525 provided on the outside of the holding portion 522.

The movable portion 521 is formed to a greater thickness dimension than the holding portion 522. The movable portion 521 is formed to a diameter dimension that is at least larger than the diameter dimension of the outer peripheral edge of the reflection film installation surface 512A as viewed in the filter plan view. The movable electrode 562 and a movable reflection film 55 as a second reflection film according to the invention are provided on the movable portion 521.

The movable electrode 562 faces the fixed electrode 561 via an inter-electrode gap G2 and is formed annularly in the same shape as the fixed electrode 561. Also, a movable lead-out electrode 564 extending from the outer peripheral edge of the movable electrode 562 toward the second electric installation surface 524 is provided on the movable substrate 52. An extending distal end portion of the movable lead-out electrode 564 (a portion situated at the vertex C4 of the movable substrate 52) forms a movable electrode pad 564P on the second electric installation surface 524.

The movable reflection film 55 is provided at a central part of a movable surface 521A of the movable portion 521, facing the fixed reflection film 54 via an inter-reflection film gap G1.

The holding portion 522 is a diaphragm surrounding the movable portion 521 and is formed to a smaller thickness dimension than the movable portion 521. Such a holding portion 522 is more flexible than the movable portion 521 and can displace the movable portion 521 toward the fixed substrate 51 with a very small electrostatic attraction.

The substrate outer peripheral portion 525 is provided on the outside of the holding portion 522 as viewed in the filter plan view, as described above. A surface facing the fixed substrate 51 of the substrate outer peripheral portion 525 has the second joining portion 523 that faces the first joining portion 513. The second joining film 532 is provided on the second joining portion 523. As the second joining film 532 is joined to the first joining film 531, as described above, the fixed substrate 51 and the movable substrate 52 are joined together.

### Configuration of Casing

Back to FIGS. 1 and 2, the casing 601 has a base substrate 610, a lid 620, a base-side glass substrate 630 (light-transmissive substrate), and a lid-side glass substrate 640 (light-transmissive substrate).

The base substrate 610 is formed, for example, by a single-layer ceramic substrate. On the base substrate 610, the movable substrate 52 of the variable-wavelength interference filter 5 is installed. To install the movable substrate 52 on the base substrate 610, for example, the movable substrate 52 may be arranged via an adhesive layer or the like, or may be fitted with another fixing member or the like.

In the base substrate 610, a light transmission hole 611 is opened in a region facing the reflection films (the fixed reflection film 54, the movable reflection film 55) of the variable-wavelength interference filter 5.

On a base inner surface 612 facing the lid 620 (lid facing surface) of the base substrate 610, an inner terminal portion 615 connected to each electrode pad 563P, 564P on the first electric installation surface 514 and the second electric installation surface 524 of the variable-wavelength interference filter 5 is provided.

Also, in the base substrate 610, a through-hole 614 is formed corresponding to the position where each inner terminal portion 615 is provided. Each inner terminal portion 615 is connected via the through-hole 614 to an outer terminal portion 616 provided on a base outer surface 613 opposite to the base inner surface 612 of the base substrate 610. Here, the through-hole 614 is filled with a metal member (for example, W, Au, Ni, Ag paste or the like) connecting the inner terminal portion 615 and the outer terminal portion 616, and airtightness of an internal space 650 of the casing 601 is maintained.

On an outer peripheral portion of the base substrate 610, a base joining portion 617 joined to the lid 620 is provided.

The lid 620 has a lid joining portion 624 joined to the base joining portion 617 of the base substrate 610, a sidewall portion 625 continuing from the lid joining portion 624 and standing up in a direction away from the base substrate 610, and a top portion 626 continuing from the sidewall portion 625 and covering the side of the fixed substrate 51 of the variable-wavelength interference filter 5, as shown in FIGS. 1 and 2. The lid 620 can be made of an alloy such as Kovar or a metal.

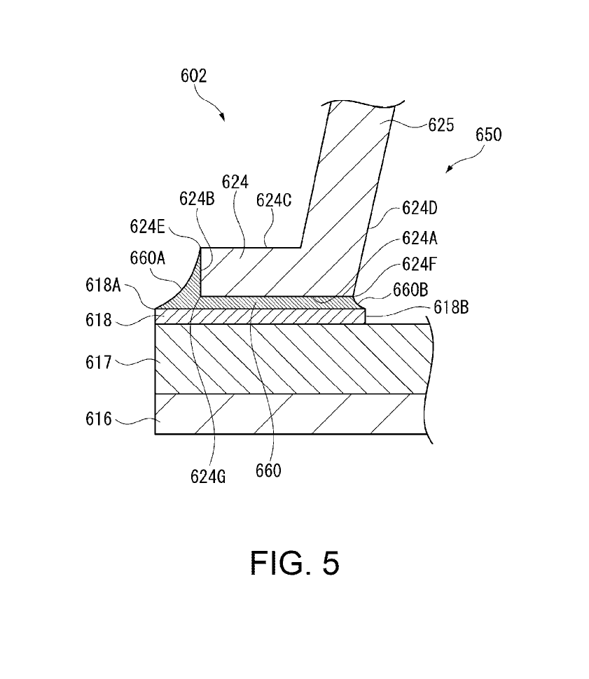

The lid 620 is tightly joined to the base substrate 610 as the lid joining portion 624 and the base joining portion 617 of the base substrate 610 are joined together by brazing using a brazing filler 660 (see FIG. 5) via a metal pattern 618 formed on the base substrate 610. In this embodiment, a gold-based solder is used as the brazing filler 660. Also, the brazing filler 660 is not limited to this example. For example, various hard brazing fillers such as silver brazing filler, or various soft brazing fillers other than gold-based solder may be used.

The configuration of a joining portion 602 where the base substrate 610 and the lid 620 are joined together by brazing will be described in detail later.

The top portion 626 of the lid 620 is parallel to the base substrate 610. In the top portion 626, a light transmission hole 621 is opened in a region facing respective reflection films 54, 55 of the variable-wavelength interference filter 5. Light becomes incident trough the light transmission hole 621 of the lid 620. The light taken out by the variable-wavelength interference filter 5 exits through the light transmission hole 611 of the base substrate 610.

The base-side glass substrate 630 is a glass substrate joined to the side of the base outer surface 613 of the base substrate 610, covering the light transmission hole 611. The base-side glass substrate 630 is formed in a larger size than the light transmission hole 611.

Similarly, the lid-side glass substrate 640 is a glass substrate joined to the side of the lid inner surface 622 opposite to the light transmission hole 621 facing the base substrate 610 of the lid 620, covering the light transmission hole 621. The lid-side glass substrate 640 is formed in a larger size than the light transmission hole 621.

To join the base substrate 610 and the base-side glass substrate 630 and to join the lid 620 and the lid-side glass substrate 640, for example, glass frit bonding using glass frit that is formed by melting a glass material at a high temperature and then quickly cooling the melted glass material, or bonding by deposition with a low-melting glass, glass sealing or the like may be used. Although not suitable for maintaining a vacuum state in the internal space 650, bonding with an epoxy resin or the like may be used, for example, if it is only for the purpose of restraining entry of foreign matters into the internal space 650.

In the optical filter device 600 thus configured, the proportion of the region facing the variable-wavelength interference filter 5 occupying the region on the inner side of an inner end 624F (see FIG. 5) of the lid joining portion 624, on the base substrate 610, is 90% or greater, as viewed in a plan view seen from the direction of thickness of the base substrate 610 (hereinafter referred to as abase substrate plan view).

### Configuration of Joining Portion

FIG. 5 is a sectional view showing the schematic configuration of the joining portion 602 joining the base joining portion 617 and the lid joining portion 624 together.

As shown in FIG. 5, the outer peripheral edge of the base joining portion 617 of the base substrate 610 is situated on the outer side from the lid joining portion 624, as viewed in the base substrate plan view.

On the base inner surface 612, the metal pattern 618 is formed in the base joining portion 617.

The metal pattern 618 is a metal layer made of a metal material having higher wettability to the brazing filler 660 than the base substrate 610. The metal pattern 618 is formed in such a way that an outer edge portion 618A of the metal pattern 618 is situated on the outer side from the lid joining portion 624 as viewed in the base substrate plan view, and in this embodiment, situated on the same position as the edge portion of the base joining portion 617. Also, the metal pattern 618 is provided in such a way that an inner edge portion 618B of the metal pattern 618 is situated at a position facing the inner end 624F of the lid joining portion 624 or slightly on the inner side thereof, as viewed in the base substrate plan view.

The lid joining portion 624 has a base facing surface 624A that faces the base substrate 610, an inner lateral surface 624D that continues at the inner end 624F on the side of the internal space 650 of the base facing surface 624A and faces the internal space 650, an outer lateral surface 624B that continues at an outer end 624G opposite to the inner end 624F of the base facing surface 624A, and an upper surface 624C that continues at an upper end 624E opposite to the outer end 624G of the outer lateral surface 624B.

The base facing surface 624A and the outer lateral surface 624B of the lid joining portion 624 are plated with a metal having higher wettability to the brazing filler 660 than the main body of the lid 620, for example, plated with Ni/Au.

Meanwhile, the above plating is not done on the inner lateral surface 624D of the lid joining portion 624. Therefore, the inner lateral surface 624D has lower wettability to the brazing filler 660 than the base facing surface 624A.

The brazing filler 660 is provided along the base facing surface 624A and the outer lateral surface 624B from the inner end 624F of the lid joining portion 624 to the upper end 624E via the outer end 624G, as shown in FIG. 5.

The brazing filler 660 forms a fillet 660A that expands outward as viewed in the base substrate plan view, from the upper end 624E toward the outer edge portion 618A of the metal pattern 618.

The brazing filler 660 also forms a fillet 660B that expands inward as viewed in the base substrate plan view, from the inner end 624F toward the inner edge portion 618B of the metal pattern 618.

The brazing filler 660, thus provided, joins the base joining portion 617 and the lid joining portion 624 together via the metal pattern 618.

In this embodiment, the metal pattern 618 is provided in such a way that the outer edge portion 618A thereof is situated on the outer side from the outer end 624G of the lid joining portion 624 as viewed in the base substrate plan view.

Moreover, the metal pattern 618 has higher wettability to the brazing filler 660 than the base substrate 610. Therefore, the fillet 660A is formed from the upper end 624E of the lid joining portion 624 to the outer edge portion 618A of the metal pattern 618.

Thus, the metal pattern 618 is formed in such a way that the outer edge portion 618A of the metal pattern 618 is at an optimum position on the outer side from the upper end 624E as viewed in the base substrate plate view, so that the fillet 660A capable of securing joining performance and airtightness can be formed.

Also, the inner end portion of the brazing filler 660 is at the same position as the inner edge portion 618B of the metal pattern 618. Therefore, the position of the inner edge portion 618B of the metal pattern 618 may be a position where the brazing filler 660 does not interfere with various components arranged inside the internal space 650. By arranging the position of the inner edge portion 618B slightly on the inner side from the inner end 624F, the fillet 660B can be formed and good joining performance and airtightness can be secured similarly.

### Method for Manufacturing Optical Filter Device

Next, a method for manufacturing the above optical filter device 600 will be described with reference to the drawings.

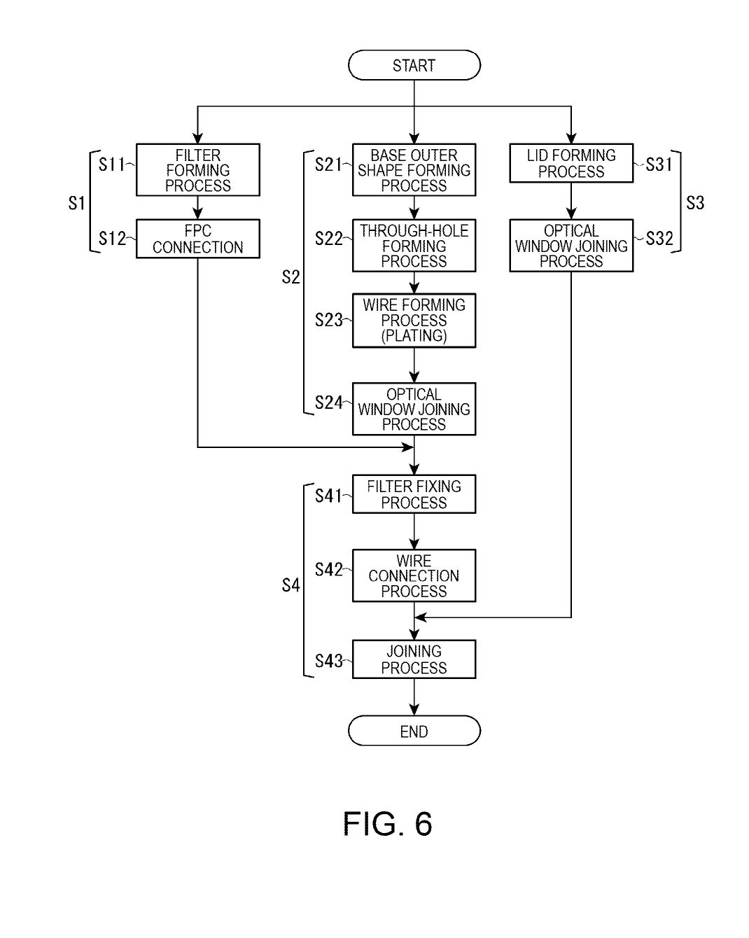

FIG. 6 shows processes of manufacturing the optical filter device 600.

In manufacturing the optical filter device 600, a filter preparation process (S1) to manufacture the variable-wavelength interference filter 5 constituting the optical filter device 600, a base substrate preparation process (S2), and a lid preparation process (S3) are carried out first.

### Filter Preparation Process

In the filter preparation process S1, first, a filter forming process to manufacture the variable-wavelength interference filter 5 is carried out (S11).

In this S11, the fixed substrate 51 and the movable substrate 52 are formed suitably by etching or the like. On the fixed substrate 51, after the fixed electrode 561 and the fixed lead-out electrode 563 are deposited, the fixed reflection film. 54 is deposited. On the movable substrate 52, after the movable electrode 562 is deposited, the movable reflection film 55 is deposited.

Then, the fixed substrate 51 and the movable substrate 52 are joined together via the joining film. 53, thus providing the variable-wavelength interference filter 5.

After that, an FPC connection process to connect an FPC 615A to the fixed electrode pad 563P and the movable electrode pad 564P of the variable-wavelength interference filter 5 provided by S11 is carried out (S12). To connect the FPC 615A and respective electrode pads 563P, 564P, Ag paste that has little degassing is used.

### Base Substrate Preparation Process

In the base substrate preparation process S2, first, a base outer shape forming process is carried out (S21). In this S21, a substrate before burning, formed by stacking sheets as forming materials of a ceramic substrate, is properly cut and the shape of the base substrate 610 having the light transmission hole 611 is formed. Then, the substrate before burning is burned to form the base substrate 610.

The light transmission hole 611 may be formed in the burned base substrate 610 by processing using a high-output laser, for example, YAG laser or the like.

Next, a through-hole forming process to form the through-hole 614 in the base substrate 610 is carried out (S22). In this S22, in order to form a fine through-hole 614, laser processing using, for example, YAG laser or the like, is carried out. Also, the resulting through-hole 614 is filled with a conductive member with high contactability.

After that, a wire forming process to form the inner terminal portion 615 and the outer terminal portion 616 on the base substrate 610 is carried out (S23).

In this S23, for example, plating with a metal such as Ni/Au is carried out to form the inner terminal portion 615 and the outer terminal portion 616. Also, in order to join the base joining portion 617 and the lid joining portion 624 together by brazing, the base joining portion 617 is plated with Ni or the like to form the metal pattern 618 for joining.

After that, an optical window joining process to join the base-side glass substrate 630 covering the light transmission hole 611 to the base substrate 610 is carried out (S24).

In S24, the base-side glass substrate 630 is formed and alignment adjustment is carried out so that the plan center of the base-side glass substrate 630 and the plan center of the light transmission hole 611 coincide with each other. Then, the base-side glass substrate 630 is joined to the base substrate 610 by frit glass bonding using frit glass.

### Lid Preparation Process

In the lid preparation process S3, first, a lid forming process to form the lid 620 is carried out (S31). In this S31, a metal substrate made of Kovar or the like is press-worked to form the lid 620 having the light transmission hole 621. Moreover, in this embodiment, the base facing surface 624A and the outer lateral surface 624B of the lid joining portion 624 are plated with a metal having higher wettability to the brazing filler 660 than the lid 620, for example, plated with Ni/Au.

After that, an optical window joining process to join the lid-side glass substrate 640 covering the light transmission hole 621 to the lid 620 is carried out (S32).

In S32, similarly to S24, the lid-side glass substrate 640 is formed and alignment adjustment is carried out so that the plan center of the lid-side glass substrate 640 and the plan center of the light transmission hole 621 coincide with each other. Then, the lid-side glass substrate 640 is joined to the lid 620 by frit glass bonding using frit glass.

### Device Assembling Process

Next, a device assembling process to join together the variable-wavelength interference filter 5, the base substrate 610 and the lid 620 obtained through the above S1 to S3, thus forming the optical filter device 600, is carried out (S4).

In this S4, first, a filter fixing process to fix the variable-wavelength interference filter 5 to the base substrate 610 is carried out (S41). In this S41, alignment adjustment is carried out so that the plan center point O of the fixed reflection film 54 and the movable reflection film 55 and the plan center point O of the light transmission hole 611 coincide with each other. Then, the substrate outer peripheral portion 525 of the movable substrate 52 is adhered and fixed to the base substrate 610, for example, using an adhesive or the like.

Then, a wire connection process is carried out (S42). In this S42, the other end of the FPC 615A connected to the variable-wavelength interference filter 5 in S12 is bonded to the inner terminal portion 615 on the base substrate 610, and the inner terminal portion 615, and the fixed electrode pad 563P and the movable electrode pad 564P are thus connected to each other. Also in this connection, it is preferable to use Ag paste that has little degassing.

After that, a joining process to join the base substrate 610 and the lid 620 together is carried out (S43). In this S43, joining is carried out in an environment that is set into a vacuum atmosphere, for example, in a vacuum chamber device or the like. Specifically, a proper amount of the brazing filler 660 in a molten state is arranged on the metal pattern 618, and the lid 620 is superimposed thereon. At this point, since the base facing surface 624A and the outer lateral surface 624B of the lid joining portion 624 are plated and thus have good wettability, the brazing filler 660 climbs up the outer lateral surface 624B. Meanwhile, the brazing filler 660 does not climb up the inner lateral surface 624D, which is not plated, and the brazing filler 660 stops at the outer end 624G. As the brazing filler 660 is cooled in this state, the fillets 660A, 660B are formed and the base substrate 610 and the lid 620 are tightly joined together.

Through the above processes, the optical filter device 600 is manufactured.

### Effects and Advantages of First Embodiment

In the optical filter device 600 of this embodiment, the brazing filler 660 is provided along the base facing surface 624A and the outer lateral surface 624B from the inner end 624F of the lid joining portion 624 to the upper end 624E via the outer end 624G.

In such a configuration, the brazing filler 660 does not contact the inner lateral surface 624D of the lid joining portion 624. The brazing filler 660 is formed to contact the lid joining portion 624 on the outside of the inner end 624F, from the inner end 624F of the base facing surface 624A of the lid joining portion 624.

Therefore, the volume of the brazing filler formed in the internal space 650 of the casing 601 can be reduced, compared with the case where a fillet expanding toward the inner side from the inner lateral surface 624D of the lid joining portion 624 is formed. Thus, there is no need to secure a space for preventing interference between the fillet and various members arranged in the internal space 650, as a part of the internal space 650, and therefore the casing 601, that is, the optical filter device 600 can be reduced in size.

Moreover, since a fillet expanding toward the inner side from the inner lateral surface 624D is not formed, the volume of the brazing filler can be reduced. Therefore, the amount of the brazing filler used can be restrained and the manufacturing cost can be restrained.

In the optical filter device 600 of this embodiment, since the brazing filler 660 is formed up to the upper end 624E of the outer lateral surface 624B of the lid joining portion 624, the fillet 660A that can secure joining strength and airtightness can be formed on the outer side of the lid joining portion 624.

Moreover, since the fillet 660A is formed, joining by brazing is properly carried out, and whether joining strength and airtightness are secured or not can be visually recognized easily.

The joining process S43 is carried out by brazing. In this joining process S43, if the brazing filler 660 climbs up the upper surface 624C and the inner lateral surface 624D of the lid joining portion 624, the brazing filler cannot be secured in a sufficient amount to form the fillet 660A along the outer lateral surface 624B, and desired joining strength and airtightness may not be achieved.

However, in the optical filter device 600 of this embodiment, the base facing surface 624A and the outer lateral surface 624B of the lid joining portion 624 are plated with a metal having higher wettability to the brazing filler 660 than the main body of the lid 620. As the wettability of the inner lateral surface 624D of the lid joining portion is lower than the base facing surface 624A, the climbing of the brazing filler 660 onto the inner lateral surface 624D from the inner end 624F of the base facing surface 624A can be restrained. Thus, the formation of a fillet expanding toward the inside of the lid 620 can be deterred.

In this way, according to this embodiment, the formation of a fillet from the inner lateral surface 624D is deterred and the fillet 660A expanding outward from the upper end 624E of the outer lateral surface 624B can be formed. Therefore, since the brazing filler 660 can be formed in a desired region, joining strength and airtightness can be secured while the amount of the brazing filler used can be restrained further.

By the way, in this embodiment, the plating is not performed on the upper surface 624C of the lid joining portion 624. However, the upper surface 624C may be plated. In such a case, too, the angle formed by the outer lateral surface 624B and the upper surface 624C may be an acute angle (in the embodiment, 90 degrees) and the climbing of the brazing filler 660 onto the upper surface 624C from the upper end 624E of the outer lateral surface 624B can be restrained. Also, if the upper surface 624C is not plated, the wettability thereof to the brazing filler 660 is lower than the outer lateral surface 624B and therefore the climbing of the brazing filler 660 onto the upper surface 624C can be deterred suitably.

While plating is mentioned as a configuration to provide the difference in wettability, other methods than plating may also be used to provide the difference in wettability.

In the optical filter device 600 of the embodiment, the proportion of the region facing the variable-wavelength interference filter 5 to the region on the inner side from the inner end 624F of the lid joining portion 624 is 90% or greater, as viewed in the base substrate plan view of the base substrate 610. Thus, the size of the gap provided between the variable-wavelength interference filter 5 and the inner surface of the lid sidewall portion 625 can be reduced in the direction of width orthogonal to the direction of thickness of the base substrate 610, and the optical filter device 600 can be reduced in size.

In the embodiment, the variable-wavelength interference filter 5 is housed in the casing 601 and the joining strength and airtightness of the optical filter device 600 can be secured as described above. Thus, entry of charged particles into the casing 601 can be prevented. Therefore, change in the gap between the reflection films by the influence of a Coulomb force due to electric charging of the fixed reflection film 54 and the movable reflection film 55 can be prevented, and desired performance can be achieved.

Also, entry of foreign matters such as water particles can be prevented and deterioration of the fixed reflection film 54 and the movable reflection film 55 can be restrained.

In the embodiment, the internal space 650 of the casing 601 is maintained in a vacuum state. Also, in the variable-wavelength interference filter 5, by applying a voltage to the fixed electrode 561 and the movable electrode 562, the movable portion 521 can be moved toward the fixed substrate 51, thus changing the size of the inter-reflection film gap G1.

In such a configuration, since the internal space 650 is in a vacuum state, the inter-reflection film gap G1 is also in a vacuum state. Thus, no air resistance acts when the movable portion 521 is moved, and responsiveness to the application of a voltage to the fixed electrode 561 and the movable electrode 562 can be improved. Therefore, the inter-reflection film gap G1 can be quickly set to a desired size, and quick processing can be carried out, for example, in the case where various kinds of processing such as measurement using the optical filter device 600 are carried out.

### Second Embodiment

Next, a second embodiment of the invention will be described with reference to the drawings.

The second embodiment is another embodiment of the joining portion 602 of the optical filter device 600 of the first embodiment.

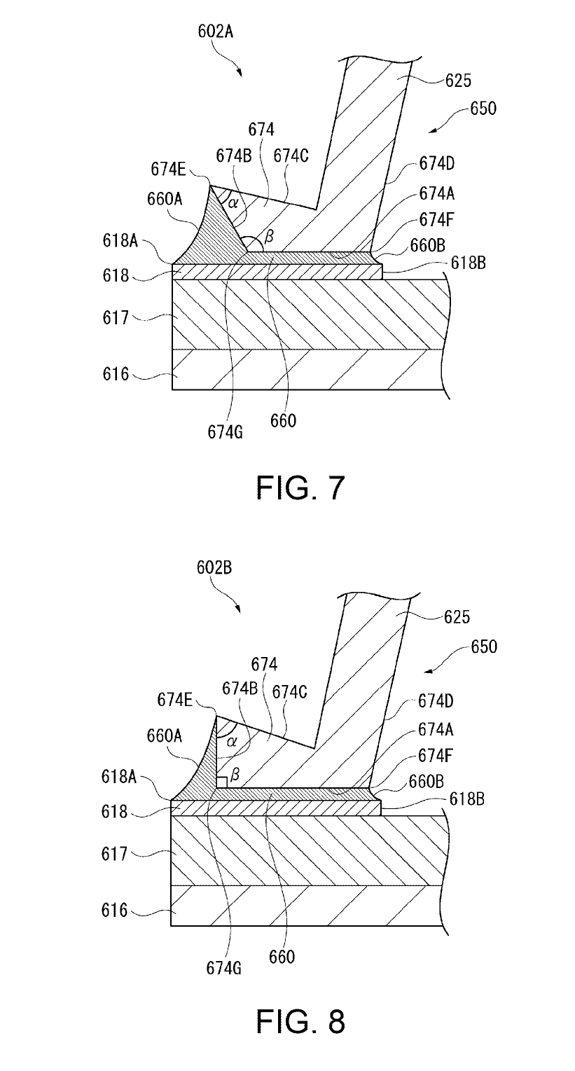

FIG. 7 is a sectional view showing the schematic configuration of a joining portion 602A according to the second embodiment.

The same members as in the first embodiment are denoted by the same reference numerals and the description thereof is simplified or omitted.

### Configuration of Joining Portion

As shown in FIG. 7, a lid joining portion 674 is joined to the base joining portion 617 of the base substrate 610 with the brazing filler 660 formed along the metal pattern 618.

In this embodiment, too, a base facing surface 674A facing the base substrate 610, and an outer lateral surface 674B of the lid joining portion 674 are plated with a metal having higher wettability to the brazing filler 660 than the main body of the lid 620. An inner lateral surface 674D has lower wettability to the brazing filler 660 than the base facing surface 674A.

In this embodiment, as shown in FIG. 7, the angle α formed by the outer lateral surface 674B and the upper surface 674C of the lid joining portion 674 is an acute angle. It is preferable that the angle α is 45 to 90 degrees.

The angle β formed by the base facing surface 674A and the outer lateral surface 674B of the lid joining portion 674 is an obtuse angle. It is preferable that the angle β is 90 to 135 degrees.

The brazing filler 660 is provided along the base facing surface 674A and the outer lateral surface 674B from an inner end 674F of the lid joining portion 674 to an upper end 674E via an outer end 674G, as shown in FIG. 7.

The brazing filler 660 forms a fillet 660A expanding outward, from the upper end 674E of the outer lateral surface 674B where the outer lateral surface 674B and the upper surface 674C of the lid joining portion 674 are connected together, toward the outer edge portion 618A of the metal pattern 618.

The brazing filler 660 also forms a fillet 660B expanding inward, from the inner end 674F of the base facing surface 674A toward the inner edge portion 618B of the metal pattern 618.

The fillet 660B on the inner side may not necessarily be formed in this embodiment, either. The metal pattern 618 may be formed in such a way that the inner edge portion 618B is situated at the same position as the inner end 674F of the lid joining portion 674 or on the inner side thereof, in the direction of extension of the base substrate 610.

### Effects and Advantages of Second Embodiment

The optical filter device having the joining portion 602A of this embodiment can achieve the following effects in addition to the effects of the first embodiment.

That is, since the angle α formed by the outer lateral surface 674B and the upper surface 674C of the lid joining portion 674 is an acute angle, the climbing of the brazing filler 660 onto the upper surface 674C of the lid joining portion 674 from the upper end 674E of the outer lateral surface 674B can be restrained suitably. Thus, the fillet 660A can be formed suitably from the upper end 674E of the outer lateral surface 674B of the lid joining portion 674, and joining strength and airtightness can be secured while the amount of the brazing filler 660 used can be restrained.

In the optical filter device having the joining portion 602A of this embodiment, since the angle β formed by the base facing surface 674A and the outer lateral surface 674B of the lid joining portion 674 is an obtuse angle, the angle α formed by the outer lateral surface 674B and the upper surface 674C can be made an acute angle and the climbing of the brazing filler 660 onto the upper surface 674C of the lid joining portion 674 can be restrained more suitably. Thus, the fillet 660A can be formed suitably from the upper end 674E of the outer lateral surface 674B of the lid joining portion 674, and joining strength and airtightness can be secured while the amount of the brazing filler 660 used can be restrained.

It is preferable that the angle α formed by the outer lateral surface 674B and the upper surface 674C of the lid joining portion 674 is 45 to 90 degrees. Also, it is preferable that the angle β formed by the base facing surface 674A and the outer lateral surface 674B is 90 to 135 degrees. Thus, the climbing of the brazing filler 660 onto the upper surface 674C can be deterred and the strength of the lid joining portion 674 can be secured.

### Modification of Second Embodiment

FIG. 8 is a sectional view showing the schematic configuration of a joining portion 602B as a modification of the second embodiment.

In the joining portion 602A according to the second embodiment shown in FIG. 7, the angle α formed by the outer lateral surface 674B and the upper surface 674C of the lid joining portion 674 is an acute angle and the angle β formed by the base facing surface 674A and the outer lateral surface 674B is an obtuse angle. Meanwhile, in the joining portion 602B in this modification, the angle α formed by the outer lateral surface 674B and the upper surface 674C is an acute angle and the angle β formed by the base facing surface 674A and the outer lateral surface 674B is a right angle instead of an obtuse angle.

In this modification thus configured, since the angle α is an acute angle, the climbing of the brazing filler 660 onto the upper surface 674C of the lid joining portion 674 from the upper end 674E of the outer lateral surface 674B can be restrained. Thus, the fillet 660A can be formed suitably from the upper end 674E of the outer lateral surface 674B of the lid joining portion 674, and joining strength and airtightness can be secured while the amount of the brazing filler 660 used can be restrained.

In this modification, an example where the angle α formed by the outer lateral surface 674B and the upper surface 674C is an acute angle while the angle β formed by the base facing surface 674A and the outer lateral surface 674B is a right angle, is described. However, the angle α may be a right angle and the angle β may be an obtuse angle.

In this case, since the angle β is an obtuse angle, the climbing of the brazing filler 660 onto the upper surface of the lid joining portion can be restrained. Also, in this case, the lid joining portion 674 has a shape with the thickness thereof increasing as it goes inward in the base substrate plan view. Thus, the strength of the lid joining portion 674 can be increased.

### Third Embodiment

Next, a third embodiment of the invention will be described with reference to the drawings.

The third embodiment is another embodiment of the joining portion 602 of the optical filter device 600 of the first embodiment.

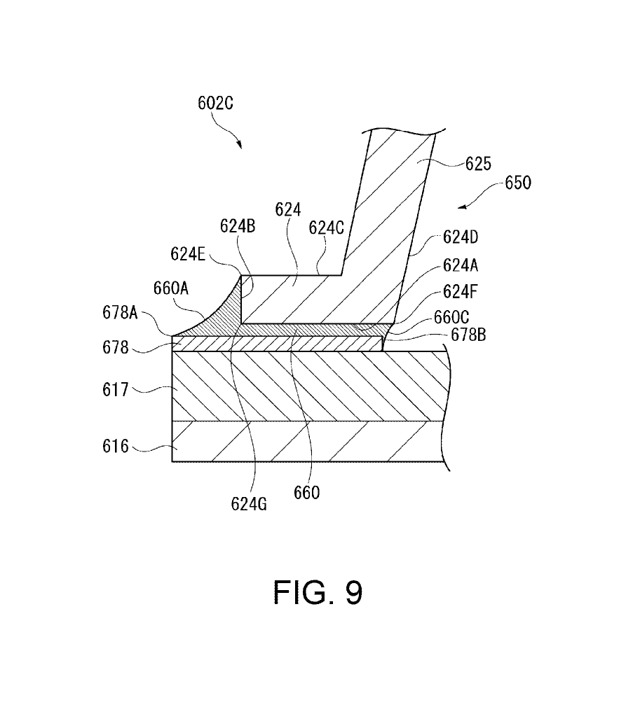

FIG. 9 is a sectional view showing the schematic configuration of a joining portion 602C according to the third embodiment.

The same members as in the first embodiment are denoted by the same reference numerals and the description thereof is simplified or omitted.

### Configuration of Joining Portion

As shown in FIG. 9, in the joining portion 602C, a metal pattern 678 is provided on the outer side of the position facing the inner end 642F of the lid joining portion 624, and an inner edge portion 678B of the metal pattern 678 is situated on the outer side of the position facing the inner end 642F of the lid joining portion 624, as viewed in the base substrate plan view.

In this embodiment, too, the base facing surface 624A and the outer lateral surface 624B of the lid joining portion 624 are plated with a metal having higher wettability to the brazing filler 660 than the main body of the lid 620.

The brazing filler 660 forms the fillet 660A expanding outward from the upper end 674E toward an outer edge portion 678A of the metal pattern 678, as in the first embodiment.

Meanwhile, the brazing filler 660 forms a fillet 660C expanding inward from the inner edge portion 678B of the metal pattern 678 toward the inner end 624F of the base facing surface 624A.

In this embodiment, the position of the inner edge portion 678B of the metal pattern 678 as viewed in the base substrate plan view is set in accordance with the position of the inner end 624F of the lid joining portion 624 as viewed in the base substrate plan view and the distance between the base joining portion 617 and the lid joining portion 624, or the like, so that the fillet 660C is formed.

As long as desired joining strength and airtightness can be secured, in the base substrate plan view, the position of the inner edge portion 678B is not particularly limited and may be on the outer side of the inner end 624F and on the inner side of the outer end 624G.

### Effects and Advantages of Third Embodiment

The optical filter device having the joining portion 602C of this embodiment can achieve the following effects in addition to the effects of the first embodiment.

That is, in the base substrate plan view, the metal pattern 678 having higher wettability to the brazing filler 660 than the base substrate 610 is formed on the outer side of the position facing the inner end 624F of the lid joining portion 624. As this metal pattern 678 is formed, the fillet 660C extending from the inner edge portion 678B of the metal pattern 678 to the inner end 624F is formed between the lid joining portion 624 and the base substrate 610. That is, in the base substrate 610, the brazing filler 660 does not expand toward the internal space 650 on the metal pattern 678, and an inconvenience of formation of a fillet on the inner side of the lid joining portion 624 can be restrained.

### Fourth Embodiment

Next, a fourth embodiment of the invention will be described with reference to the drawings.

In the fourth embodiment, a color measurement sensor 3 as an optical module in which the optical filter device 600 of the first to third embodiments is incorporated, and a color measurement device 1 as an example of an electronic apparatus in which the optical filter device 600 is incorporated, will be described.

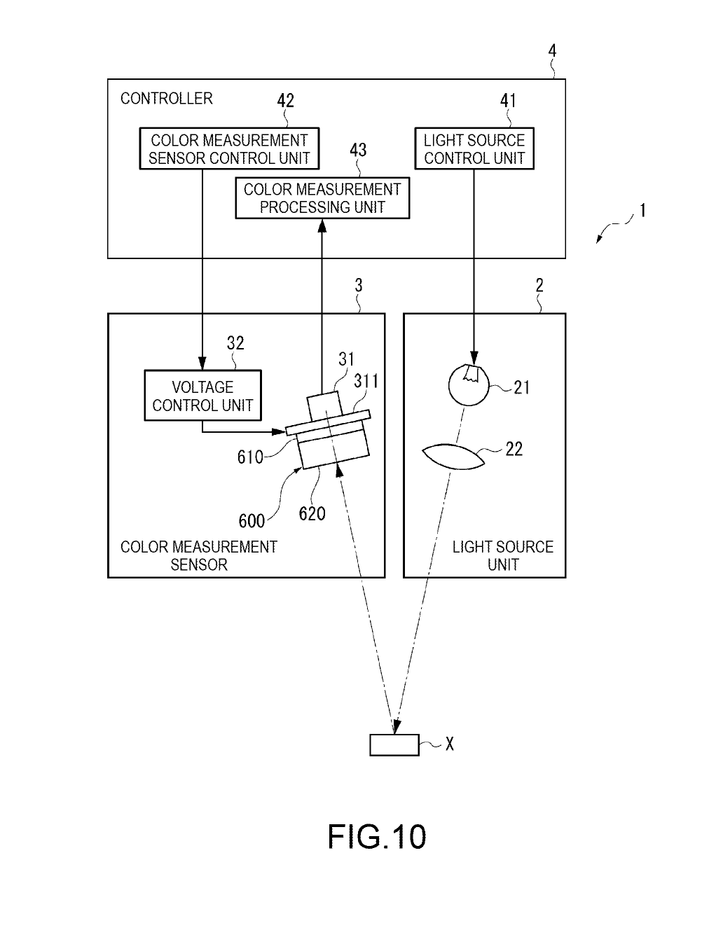

FIG. 10 is a block diagram showing the schematic configuration of the color measurement device 1 according to the fourth embodiment.

The color measurement device 1 is an electronic apparatus according to the invention. The color measurement device 1 has a light source unit 2 that emits light to an inspection target X, a color measurement sensor 3 (optical module), and a controller 4 that controls the overall operation of the color measurement device 1, as shown in FIG. 10. The color measurement device 1 is a device in which light emitted from the light source unit 2 is reflected by the inspection target X, then the reflected inspection target light is received by the color measurement sensor 3, and based on a detection signal outputted from the color measurement sensor 3, the chromaticity of the inspection target light, that is, the color of the inspection target X, is analyzed and measured.

### Configuration of Light Source Unit

The light source unit 2 has a light source 21 and plural lenses 22 (in FIG. 10, only one lens is shown), and emits white light to the inspection target X. The plural lenses 22 may include a collimating lens, and in such a case, the light source unit 2 causes the collimating lens to collimate the white light emitted from the light source 21 and emits the collimated light toward the inspection target X from a projection lens, not shown. While the color measurement device 1 having the light source unit 2 is described as an example in this embodiment, a configuration without having the light source unit 2 may be used, for example, if the inspection target X is a light emitting member such as a liquid crystal panel.

### Configuration of Color Measurement Sensor

The color measurement sensor 3 constitutes the optical module according to the invention and has the optical filter device 600, a detection unit 31 that receives light transmitted through the variable-wavelength interference filter 5 of the optical filter device 600, and a voltage control unit 32 that varies the wavelength of the light transmitted through the variable-wavelength interference filter 5, as shown in FIG. 10.

The color measurement sensor 3 also has an incident optical lens, not shown, that guides inside the reflected light (inspection target light) reflected by the inspection target X, at a position facing the variable-wavelength interference filter 5. The color measurement sensor 3 spectroscopically splits light with a predetermined wavelength, of the inspection target light incident from the incident optical lens, using the variable-wavelength interference filter 5 in the optical filter device 600, and receives the spectroscopically split light at the detection unit 31. The color measurement sensor 3 also has an incident optical lens, not shown, that guides inside the reflected light (inspection target light) reflected by the inspection target X, at a position facing the optical filter device 600. The color measurement sensor 3 spectroscopically splits light with a predetermined wavelength, of the inspection target light incident from the incident optical lens, using the variable-wavelength interference filter 5, and receives the spectroscopically split light at the detection unit 31.

The detection unit 31 is formed by plural photoelectric conversion elements and generates an electrical signal corresponding to the amount of light received. Here, the detection unit 31 is connected to the controller 4, for example, via a circuit board 311, and outputs the resulting electrical signal to the controller 4 as a light receiving signal.

The outer terminal portion 616 formed on the base outer surface 613 of the base substrate 610 is connected to the circuit board 311 and is thus connected to the voltage control unit 32 via a circuit formed on the circuit board 311.

In such a configuration, the optical filter device 600 and the detection unit 31 can be integrally formed via the circuit board 311 and the configuration of the color measurement sensor 3 can be simplified.

The voltage control unit 32 is connected to the outer terminal portion 616 of the optical filter device 600 via the circuit board 311. The voltage control unit 32 applies a predetermined step voltage between the fixed electrode pad 563P and the movable electrode pad 564P, based on a control signal inputted from the controller 4, and thereby drives an electrostatic actuator 56. Thus, an electrostatic attraction is generated in the inter-electrode gap G2 and the holding portion 522 flexes, causing the movable portion 521 to be displaced toward the fixed substrate 51. Thus, it is possible to set the inter-reflection film gap G1 to a desired dimension.

### Configuration of Controller

The controller 4 controls the overall operation of the color measurement device 1.

As the controller 4, for example, a general-purpose computer, potable information terminal, or dedicated computer for color measurement or the like can be used.

The controller 4 includes alight source control unit 41, a color measurement sensor control unit 42, and a color measurement processing unit 43 or the like constituting an analysis processing unit according to the invention, as shown in FIG. 10.

The light source control unit 41 is connected to the light source unit 2. The light source control unit 41 outputs a predetermined control signal to the light source unit 2, for example, based on the user's setting input, and causes the light source unit 2 to emit white light with predetermined brightness.

The color measurement sensor control unit 42 is connected to the color measurement sensor 3. The color measurement sensor control unit 42 sets the wavelength of light to be received by the color measurement sensor 3, for example, based on the user's setting input, and outputs a control signal to detect the amount of light received with this wavelength to the color measurement sensor 3. Thus, based on the control signal, the voltage control unit 32 of the color measurement sensor 3 sets a voltage to be applied to the electrostatic actuator 56 so that only the wavelength of light desired by the user is transmitted.

The color measurement processing unit 43 analyzes the chromaticity of the inspection target X based on the amount of light received that is detected by the detection unit 31.

### Effects and Advantages of Fourth Embodiment

The color measurement device 1 of this embodiment has the optical filter device 600 as described in the first to third embodiments. As described above, the optical filter device 600 can be reduced in size, can secure joining strength and airtightness, and has no entry of foreign matters such as water particles. Therefore, change in optical characteristics of the variable-wavelength interference filter 5 due to such foreign matters can be prevented. Thus, in the color measurement sensor 3, too, light with a target wavelength taken out with high resolution can be detected by the detection unit 31 and an accurate amount of light can be detected with respect to light with a desired target wavelength. Therefore, the color measurement device 1 can carry out accurate color analysis of the inspection target X.

The detection unit 31 is provided facing the base substrate 610. The detection unit 31 and outer terminal portion 616 provided on the base outer surface 613 of the base substrate 610 are connected to the single circuit board 311. That is, the base substrate 610 of the optical filter device 600 is arranged on the light exiting side and therefore can be arranged closely to the detection unit 31 that detects light emitted from the optical filter device 600. Therefore, laying wires on the single circuit board 311 as described above enables simplification of the wiring structure and reduction in the number of substrates.

The voltage control unit 32 may be arranged on the circuit board 311. In such a case, the configuration can be simplified further.

### Modifications of Embodiments

The invention is not limited to the foregoing embodiments. Modifications, improvement and the like within the range in which the object of the invention can be achieved are included in the invention.

For example, in the optical filter device according to each of the embodiments, the proportion of the region facing the variable-wavelength interference filter 5 to the region on the inner side of the inner end of the lid joining portion (area ratio) is 90% or greater, as viewed in the base substrate plan view of the base substrate 610. However, the invention is not limited to this example and the proportion may be less than 90%.

In each of the embodiments, the base substrate 610 and the lid 620 are joined together in a vacuum, thus manufacturing the optical filter device 600 in which the internal space 650 is maintained in a vacuum state. However, the invention is not limited to this example.

That is, one or plural hole portions communicating with the internal space 650 and the external space may be provided in a part of the lid 620 or the base substrate 610, and a sealing member such as a metal ball may be mounted in the hole portions from the side of the base outer surface 613, thus sealing the hole portions. For sealing with a metal ball, it is preferable that the metal ball is fit into the hole portion and then the temperature of the hole portion is raised to melt the metal ball onto the inner wall of the hole portion.

In such an optical filter device, the internal space 650 can be put into a vacuum state after the base substrate 610 and the lid 620 are joined together. For example, after brazing is carried out under atmospheric pressure, the air can be extracted from the internal space 650 to put the internal space 650 into a vacuum state.

In each of the embodiments, an example of the optical filter device 600 that houses the variable-wavelength interference filter 5 in which the size of the inter-reflection film gap G1 can be changed by an electrostatic attraction generated by application of a voltage to the fixed electrode 561 and the movable electrode 562 is described. However, the invention is not limited to this example. For example, as a gap changing unit to change the inter-reflection film gap G1, a dielectric actuator in which a first dielectric coil is arranged instead of the fixed electrode 561 whereas a second dielectric coil or permanent magnet is arranged instead of the movable electrode 562 may be used.

Moreover, a piezoelectric actuator may be used instead of the electrostatic actuator 56. In this case, for example, by stacking a lower electrode layer, a piezoelectric film and an upper electrode layer on the holding portion 522 and varying a voltage applied between the lower electrode layer and the upper electrode layer as an input value, the piezoelectric film can be expanded or contracted and the holding portion 522 can be flexed.

Also, while the variable-wavelength interference filter 5 is described as an example of the interference filter housed in the internal space 650, for example, an interference filter in which the size of the inter-reflection film gap G1 is fixed may be used. In this case, the holding portion 522 for flexing the movable portion 521, and the electrode arrangement groove 511 or the like for providing the fixed electrode 561 need not be formed by etching and the configuration of the interference filter can be simplified. Also, since the size of the inter-reflection film gap G1 is fixed, there is no problem of responsiveness and the internal space 650 need not be maintained in a vacuum. Thus, simplified configuration and improved manufacturability can be realized. However, even in this case, for example, if the optical filter device 600 is used in a place where there is large temperature change, the base-side glass substrate 630 and the lid-side glass substrate 640 may flex by receiving a stress due to the expansion or the like of the air inside the internal space 650. Therefore, even in the case where such an interference filter is used, it is preferable that the internal space 650 is maintained in a vacuum or reduced-pressure state.

In each of the embodiment, a variable-wavelength interference filter or interference filter is described as the device housed in the package according to the invention. However, the invention is not limited to this example.

For example, the device may be various devices such as a MEMS device like a mirror device that can precisely changes the direction of reflection of light. Particularly, the invention can be suitably applied to a package housing a device that requires airtightness of the casing 601 in order to improve performance and prevent deterioration or the like.

The lid 620 having the lid joining portion 623, the sidewall portion 625 and the top portion 626 and configured in such a way that the top portion 626 is parallel to the base substrate 610, is described. However, the invention is not limited to this example. The shape of the lid 620 may be any shape as long as the lid joining portion 624 that can be joined to the base joining portion 617 by brazing is provided and the internal space 650 capable of housing the variable-wavelength interference filter 5 can be formed between the lid 620 and the base substrate 610. For example, the top portion 626 may be curved. However, in this case, the manufacturing thereof is expected to be more complex, for example, the lid-side glass substrate 640 joined to the lid 620 needs to be curved following the lid 620 in order to maintain airtightness of the internal space 650, and only the portion closing the light transmission hole 621 must be made flat in order to prevent refraction, and the like. Therefore, it is preferable that the lid 620 having the top portion 626 parallel to the base substrate 610 is used, as in the first embodiment.

Also, while the color measurement device 1 is described in the fourth embodiment as an example of the electronic apparatus according to the invention, the optical filter device, the optical module and the electronic apparatus according to the invention can be used in various other fields.

For example, the invention can be used for an optical base system for detecting the presence of a specific substance. Such a system can be, for example, a gas detection device such as an on-vehicle gas leakage detector that detects a specific gas with high sensitivity by employing a spectroscopic measurement method using the optical filter device according to the invention, or a photoacoustic rare gas detector for breath test.

An example of such a gas detection device will be described below with reference to the drawings.

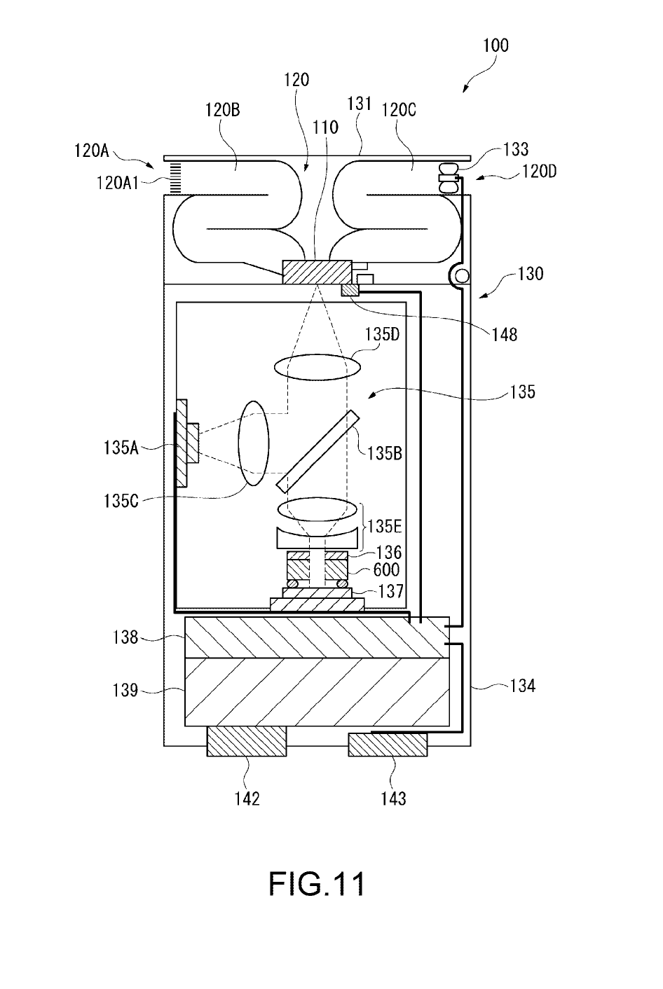

FIG. 11 is a schematic view showing an example of a gas detection device having an optical filter device.

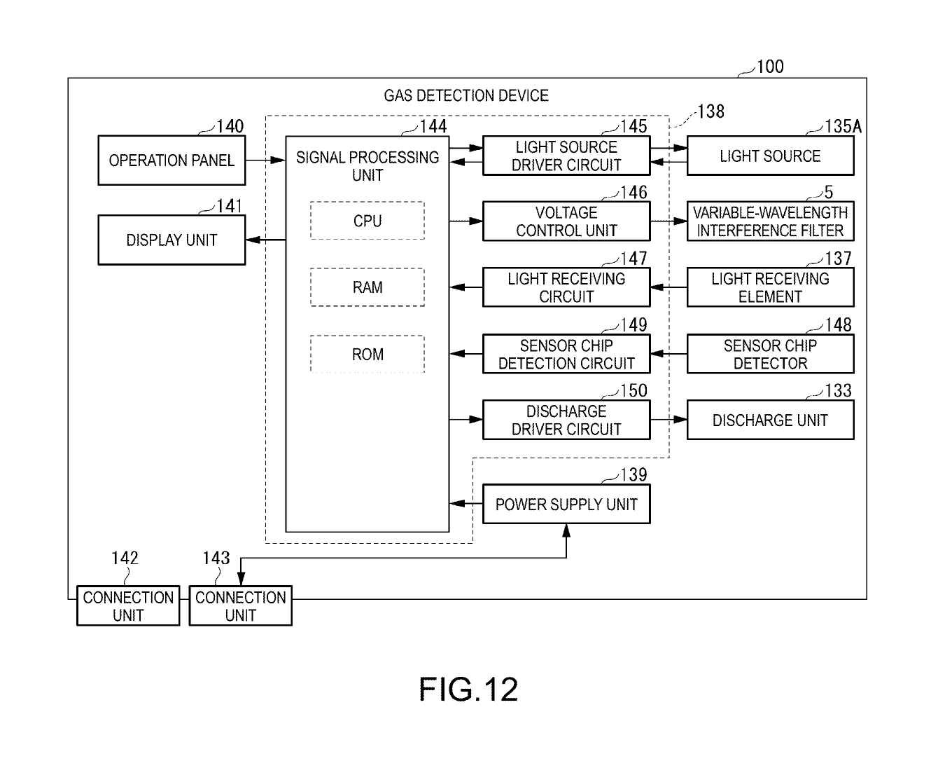

FIG. 12 is a block diagram showing the configuration of a control system of the gas detection device of FIG. 11.

A gas detection device 100 has a sensor chip 110, a flow path 120 including a suction port 120A, a suction flow path 120B, a discharge flow path 120C and a discharge port 120D, and a main body unit 130, as shown in FIG. 11.

The main body unit 130 is formed by a detection device including a sensor unit cover 131 having an opening that the flow path 120 can be attached to and removed from, a discharge unit 133, a casing 134, an optical unit 135, a filter 136, an optical filter device 600 and a light receiving element 137 (detection unit) or the like; a control unit 138 that processes a detected signal and controls the detection unit; and a power supply unit 139 that supplies electric power, and the like. The optical unit 135 includes a light source 135A that emits light, a beam splitter 135B that reflects light incident from the light source 135A toward the sensor chip 110 and transmits light incident from the sensor chip side toward the light receiving element 137, and lenses 135C, 135D, 135E.

As shown in FIG. 12, an operation panel 140, a display unit 141, a connection unit 142 for interfacing with the outside, and the power supply unit 139 are provided on the surface of the gas detection device 100. If the power supply unit 139 is a secondary battery, a connection unit 143 for charging may be provided.

Moreover, the control unit 138 of the gas detection device 100 has a signal processing unit 144 made up of a CPU or the like, a light source driver circuit 145 for controlling the light source 135A, a voltage control unit 146 for controlling the variable-wavelength interference filter 5, a light receiving circuit 147 that receives a signal from the light receiving element 137, a sensor chip detection circuit 149 receiving a signal from a sensor chip detector 148 that reads a code of the sensor chirp 110 and detects the presence or absence of the sensor chip 110, and a discharge driver circuit 150 that controls the discharge unit 133, as shown in FIG. 12.

Next, the operation of the gas detection device 100 as described above will be described hereinafter.

The sensor chip detector 148 is provided inside the sensor unit cover 131 at the top of the main body unit 130. The sensor chip detector 148 detects the presence or absence of the sensor chip 110. As the signal processing unit 144 detects a detection signal from the sensor chip detector 148, the signal processing unit 144 determines that the sensor chip 110 is installed, and sends a display signal to cause the display unit 141 to display that a detection operation is available.

Then, for example, when the user operates the operation panel 140 and an instruction signal to start detection processing is outputted from the operation panel 140 to the signal processing unit 144, first, the signal processing unit 144 outputs a light source actuation signal to the light source driver circuit 145 and thus actuates the light source 135A. As the light source 135A is driven, a stable laser beam of linearly polarized light with a single wavelength is emitted from the light source 135A. Also, since a temperature sensor and a light amount sensor are arranged inside the light source 135A, information from these sensors is outputted to the signal processing unit 144. If the signal processing unit 144 determines that the light source 135A is in stable operation, based on the temperature and the amount of light inputted from the light source 135A, the signal processing unit 144 controls the discharge driver circuit 150 to actuate the discharge unit 133. Thus, a gas sample containing a target substance (gas molecules) to be detected is guided from the suction port 120A to the suction flow path 120B, inside the sensor chip 110, the discharge flow path 120C, and the discharge port 120D. A dust filter 120A1 is provided in the suction port 120A, and relatively large dust particles, a part of water vapor and the like are eliminated.

The sensor chip 110 is a sensor which has plural metal nanostructures incorporated therein and utilizes local surface plasmon resonance. In such a sensor chip 110, an enhanced electric field is formed between the metal nanostructures by a laser beam, and if a gas molecule enters into this enhanced electric field, Raman-scattered light and Rayleigh-scatter light including information of molecular vibration are generated.

Such Rayleigh-scattered light and Raman-scattered light pass through the optical unit 135 and become incident on the filter 136. The Rayleigh-scattered light is separated by the filter 136, and the Raman-scattered light becomes incident on the variable-wavelength interference filter 5 of the optical filter device 600. The signal processing unit 144 controls the voltage control unit 146 to adjust the voltage applied to the variable-wavelength interference filter 5, and thus causes the variable-wavelength interference filter 5 to spectroscopically split the Raman-scattered light corresponding to the gas molecule as a detection target. After that, when the spectroscopically split light is received by the light receiving element 137, a light receiving signal corresponding to the amount of light received is outputted to the signal processing unit 144 via the light receiving circuit 147.

The signal processing unit 144 compares the spectrum data of the Raman-scattered light corresponding to the gas molecule as a detection target, thus obtained, with data stored in a ROM, and determines whether the gas molecule is the target gas molecule or not, and then specifies the substance. The signal processing unit 144 also causes the display unit 141 to display information of the result thereof and outputs the information of the result to outside from the connection unit 142.

In FIGS. 11 and 12, the gas detection device 100 that causes the variable-wavelength interference filter 5 of the optical filter device 600 to spectroscopically split Raman-scattered light and detects a gas from the spectroscopically split Raman-scattered light, is described as an example. However, a gas detection device that detects a gas-specific degree of light absorption and thus specifies a gas type may be used. In such a case, a gas sensor that causes a gas to flow into the sensor and detects light absorbed in the gas, of incident light, is used as an optical module according to the invention. A gas detection device that analyzes and determines the gas flowing into the sensor, using such a gas sensor, is considered as an electronic apparatus according to the invention. With this configuration, too, components of the gas can be detected using the optical filter device.

Also, as a system for detecting the presence or absence of a specific substance, a non-invasive saccharide measurement device using near infrared spectroscopy, and a non-invasive measurement device for information about food, living body, minerals and the like can be given as examples, other than the above gas detection.

Hereinafter, a food analysis device will be described as an example of the above substance component analysis device.

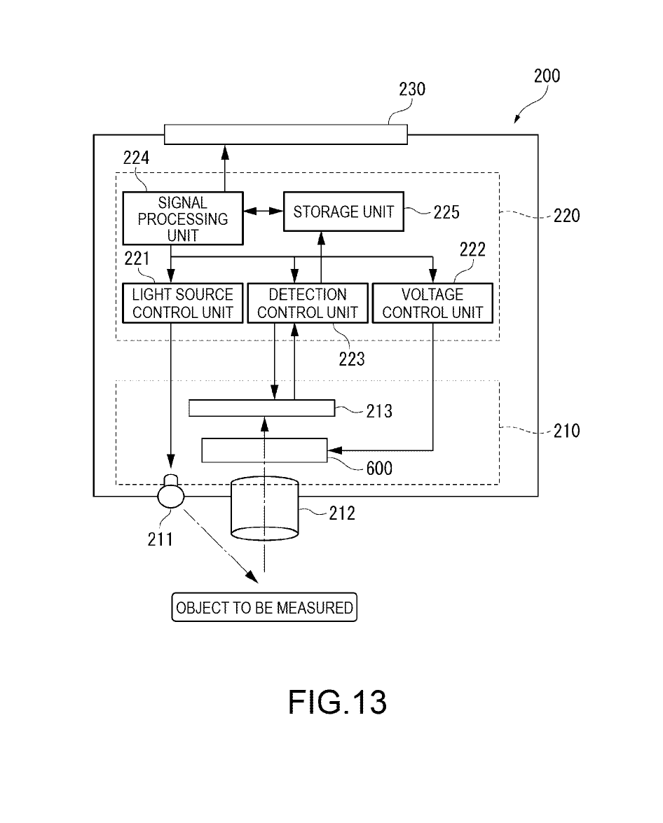

FIG. 13 shows the schematic configuration of a food analysis device as an example of an electronic apparatus using the optical filter device 600.

This food analysis device 200 has a detector 210 (optical module), a control unit 220, and a display unit 230, as shown in FIG. 13. The detector 210 has a light source 211 that emits light, an image pickup lens 212 to which light from an object to be measured is introduced, the optical filter device 600 that spectroscopically splits the light introduced from the image pickup lens 212, and a image pickup unit 213 (detection unit) that detects the spectroscopically split light.

The control unit 220 has a light source control unit 221 that carries out switching on and off of the light source 211 and brightness control when the light source 211 is on, a voltage control unit 222 that controls the variable-wavelength interference filter 5, a detection control unit 223 that controls the image pickup unit 213 and acquires a spectroscopic image picked up by the image pickup unit 213, a signal processing unit 224, and a storage unit 225.

In this food analysis device 200, when the system is driven, the light source 211 is controlled by the light source control unit 221 and light is cast from the light source 211 onto the object to be measured. Then, the light reflected by the object to be measured passes through the image pickup lens 212 and becomes incident on the variable-wavelength interference filter 5 of the optical filter device 600. A voltage that enables spectroscopic splitting of a desired wavelength is applied to the variable-wavelength interference filter 5 under the control of the voltage control unit 222. The spectroscopically split light is picked up by the image pickup unit 213 formed, for example, by a CCD camera or the like. The picked-up light is stored as a spectroscopic image in the storage unit 225. The signal processing unit 224 controls the voltage control unit 222 to change the voltage value applied to the variable-wavelength interference filter 5, and acquires a spectroscopic image corresponding to each wavelength.

The signal processing unit 224 carries out arithmetic processing of data of each pixel in each image stored in the storage unit 225 and thus finds the spectrum at each pixel. In the storage unit 225, for example, information about ingredients of food corresponding to the spectrum is stored. The signal processing unit 224 analyzes the resulting spectrum data, based on the information about food stored in the storage unit 225, and finds food ingredients contained in the detection target and the amount of the ingredients contained. Based on the resulting food ingredients and the amount of the ingredients contained, the calories, freshness and the like of the food can be calculated. Moreover, by analyzing the spectral distribution in the image, extraction of a part where freshness is lowered in the inspection target food or the like can be carried out. Also, foreign matters or the like contained in the food can be detected.

Then, the signal processing unit 224 carries out processing to cause the display unit 230 to display information about the ingredients of the inspection target food, the amount of the ingredients contained, the calories and freshness and the like, acquired as described above.

While FIG. 13 shows an example of the food analysis device 200, a non-invasive measurement device for other types of information as described above, having a substantially similar configuration, can also be used. A similar configuration can be used, for example, as a bioanalysis device that analyzes components of a living body, for example, by measuring and analyzing body fluid components such as blood. If a device that detects ethyl alcohol is used as such a bioanalysis device, for example, as a device that measures body fluid components such as blood, the device can be used as a drunk driving prevention device that detects the drunk state of the driver. Also, a similar configuration can be used as an electronic endoscope system having such a bioanalysis device.

Moreover, a similar configuration can be used as a mineral analysis device that analyzes components of minerals.

Furthermore, the package, the optical module and the electronic apparatus according to the invention can be applied to the following devices.

For example, by changing the intensity of light with each wavelength with time, it is possible to transmit data on the light with each wavelength. In this case, in an optical module having a variable-wavelength interference filter as an example of the package according to the invention, light with a specific wavelength is spectroscopically split by the variable-wavelength interference filter and then received by a light receiving unit. Thus, data transmitted on the light with the specific wavelength can be extracted. As an electronic apparatus having such an optical module for data extraction processes the data of light with each wavelength, optical communication can be carried out.

The electronic apparatus can also be applied to a spectroscopic camera, spectroscopic analyzer or the like that spectroscopically splits light by a variable-wavelength interference filter of an optical filter device as an example of the package according to the invention, and thus picks up a spectroscopic image. An example of such a spectroscopic camera may be an infrared camera having a built-in variable-wavelength interference filter.

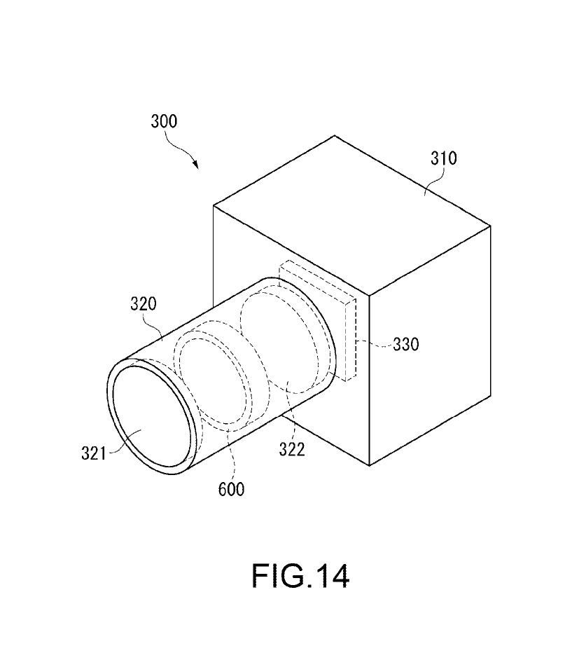

FIG. 14 is a schematic view showing the schematic configuration of a spectroscopic camera. A spectroscopic camera 300 has a camera main body 310, an image pickup lens unit 320, and an image pickup unit 330 (detection unit), as shown in FIG. 14.

The camera main body 310 is apart that the user holds and operates.

The image pickup lens unit 320 is provided on the camera main body 310 and guides incident image light to the image pickup unit 330. The image pickup lens unit 320 has an objective lens 321, an imaging lens 322, and the optical filter device 600 provided between these lenses, as shown in FIG. 14.

The image pickup unit 330 includes a light receiving element and picks up the image light guided by the image pickup lens unit 320.

In such a spectroscopic camera 300, light with a image pickup target wavelength is transmitted through the variable-wavelength interference filter 5 of the optical filter device 600, thus enabling a spectroscopic image of light with a desired wavelength to be picked up.

Moreover, an optical filter device having a variable-wavelength interference filter as an example of the package according to the invention may be used as a band-pass filter. For example, the device can be used as an optical laser device that spectroscopically splits and transmits, by the variable-wavelength interference filter, only light in a narrow range around a predetermined wavelength, of light in a predetermined wavelength range emitted from a light emitting element.

Also, an optical filter device having a variable-wavelength interference filter as an example of the package according to the invention may be used as a biometrics authentication device. For example, the device can be applied to an authentication device for blood vessel, fingerprint, retina, iris or the like, using light in a near infrared range or visible range.

Moreover, the optical module and the electronic apparatus can be used as a concentration detection device. In this case, infrared energy (infrared ray) emitted from a substance is spectroscopically split and analyzed by a variable-wavelength interference filter, thus measuring the concentration of a detection target in a sample.

As described above, the package, the optical module, and the electronic apparatus according to the invention can be applied to any device that spectroscopically splits predetermined light from incident light. Since the optical filter device having the variable-wavelength interference filter as an example of the package according to the invention can spectroscopically split plural wavelengths by the single device, as described above, measurement of the spectrum of plural wavelengths and detection of plural components can be carried out accurately. Therefore, compared with a traditional device that takes out a desired wavelength by plural devices, miniaturization of the optical module and the electronic apparatus can be promoted, and the device can be suitably used, for example, as a portable or on-vehicle optical device.

As specific structures to carry out the invention, the above embodiments and modifications may be suitably combined within a range that can achieve the object of the invention, or may be suitably changed to other structures.

The entire disclosure of Japanese Patent Application No. 2013-000355 filed on Jan. 7, 2013 is expressly incorporated by reference herein.

What is claimed is:

1. A package comprising:
a base substrate;
a lid that forms an internal space capable of housing a device between the base substrate and the lid; and
a brazing filler that joins the lid to the base substrate;
wherein the lid has: a lid joining portion having a base facing surface that faces the base substrate, an inner lateral surface that continues at an inner end on the side of the internal space of the base facing surface and faces the internal space, an outer lateral surface that continues at an outer end opposite to the inner end of the base facing surface, and an upper surface that continues at an upper end opposite to the outer end of the outer lateral surface; and a lid sidewall portion standing up in a direction away from the base substrate from the upper surface of the lid joining portion, and the brazing filler is provided along the base facing surface and the outer lateral surface from the inner end to the upper end via the outer end.

2. The package according to claim 1, wherein an area of a region facing the device on the base substrate is equal to or greater than 90% of an area of a region on the inner side from a position facing the inner end on the base substrate, as viewed in a plan view seen from a direction of thickness of the base substrate.

3. The package according to claim 1, wherein the inner lateral surface has lower wettability to the brazing filler than the base facing surface.

4. The package according to claim 1, wherein a metal pattern having higher wettability to the brazing filler than the base substrate is provided on the base substrate, and
the metal pattern is provided on the outer side from a position facing the inner end, as viewed in a plan view seen from a direction of thickness of the base substrate.

5. The package according to claim 1, wherein an angle formed by the outer lateral surface and the upper surface is an acute angle.

6. The package according to claim 1, wherein an angle formed by the base facing surface and the outer lateral surface is an obtuse angle.

7. The package according to claim 1, wherein the device is an interference filter having a first substrate, a second substrate facing the first substrate, a first reflection film that is provided on the first substrate, reflects a part of incident light and transmits a part of the incident light, and a second reflection film that is provided on the second substrate, faces the first reflection film, reflects a part of incident light and transmits a part of the incident light.

8. An optical module comprising:
an interference filter having a first substrate, a second substrate facing the first substrate, a first reflection film that is provided on the first substrate, reflects a part of incident light and transmits a part of the incident light, and a second reflection film that is provided on the second substrate, faces the first reflection film, reflects a part of incident light and transmits a part of the incident light;
a detection unit that detects light taken out by the first reflection film and the second reflection film;
a base substrate;
a lid that is joined to the base substrate and forms an internal space capable of housing the interference filter between the base substrate and the lid; and
a brazing filler that joins the lid to the base substrate;
wherein the lid has: a lid joining portion having a base facing surface that faces the base substrate, an inner lateral surface that continues at an inner end on the side of the internal space of the base facing surface and faces the internal space, an outer lateral surface that continues at an outer end opposite to the inner end of the base facing surface, and an upper surface that continues at an upper end opposite to the outer end of the outer lateral surface; and a lid sidewall portion standing up in a direction away from the base substrate from the upper surface of the lid joining portion, and
the brazing filler is provided along the base facing surface and the outer lateral surface from the inner end to the upper end via the outer end.

9. An electronic apparatus comprising:
an interference filter having a first substrate, a second substrate facing the first substrate, a first reflection film that is provided on the first substrate, reflects a part of incident light and transmits a part of the incident light, and a second reflection film that is provided on the second substrate, faces the first reflection film, reflects a part of incident light and transmits a part of the incident light;
a control unit that controls the interference filter;
a base substrate;
a lid that is joined to the base substrate and forms an internal space capable of housing the interference filter between the base substrate and the lid; and
a brazing filler that joins the lid to the base substrate;
wherein the lid has: a lid joining portion having a base facing surface that faces the base substrate, an inner lateral surface that continues at an inner end on the side of the internal space of the base facing surface and faces the internal space, an outer lateral surface that continues at an outer end opposite to the inner end of the base facing surface, and an upper surface that continues at an upper end opposite to the outer end of the outer lateral surface; and a lid sidewall portion standing up in a direction away from the base substrate from the upper surface of the lid joining portion, and
the brazing filler is provided along the base facing surface and the outer lateral surface from the inner end to the upper end via the outer end.
